(19) United States
(12) Patent Application Publication
(10) Pub. No.: US 2026/0100165 A1
(43) Pub. Date: Apr. 9, 2026

(54) GATE DRIVING CIRCUIT AND DISPLAY DEVICE INCLUDING THE SAME

(71) Applicant: LG Display Co., Ltd., Seoul (KR)

(72) Inventors: Jaehyung Jo, Goyang-si (KR); Wondoo Kim, Gimpo-si (KR); Wonho Lee, Paju-si (KR); Inyeong Kong, Seoul (KR)

(73) Assignee: LG Display Co., Ltd., Seoul (KR)

(21) Appl. No.: 19/267,214

(22) Filed: Jul. 11, 2025

(30) Foreign Application Priority Data
Oct. 8, 2024 (KR) 10-2024-0136266

(51) Int. Cl. G09G 3/3266

(52) U.S. Cl. CPC G09G 3/3266; G09G 2300/0465; G09G 2300/0814; G09G 2300/0842; G09G 2310/0281; G09G 2340/16

(57) ABSTRACT

A display device includes a first GIP driver and a second GIP driver respectively disposed on opposing sides of a display panel. Each of the first and second GIP drivers can sequentially output a scan signal. The display device further includes a first transfer circuit connected to the display panel and the first GIP driver and configured to transfer the scan signal of the first GIP driver selectively to a first scan line and a second scan line among a plurality of scan lines, and a second transfer circuit connected to the display panel and the second GIP driver and configured to transfer the scan signal of the second GIP driver selectively to the first and second scan lines. Thus, the GIP driver design is made without reducing the GIP driver dimension and thus is appropriately applied to a high PPI or DRD type display panel.

### CROSS-REFERENCE TO RELATED APPLICATION

This application claims priority to Korean Patent Application No. 10-2024-0136266 filed on Oct. 8, 2024 in the Korean Intellectual Property Office, and all the benefits accruing therefrom under 35 U.S.C. § 119, the contents of which in its entirety are herein incorporated by reference into the present application.

### BACKGROUND

### Field

The present disclosure relates to a display device, and more particularly, to a gate driving circuit capable of improving image quality and a display device including the same.

### Discussion of the Related Art

An organic light-emitting display device is a self-emission display device. Unlike the liquid crystal display device, a separate light source is not required in the organic light-emitting display device. Thus, the organic light-emitting display device can be manufactured in a lightweight and thin manner. In addition, the organic light-emitting display device is advantageous in terms of power consumption due to low voltage operation, and has excellent color gamut, fast response speed, large viewing angle, and high contrast ratio (CR), and thus is being studied as a next-generation display.

The display device includes a gate driver that supplies a scan signal to a scan line of a display panel, and the gate driver is disposed on each of both opposing sides of the display panel in a gate-in-panel (GIP) manner.

### SUMMARY OF THE DISCLOSURE

In a display device including a single feeding type GIP driver, a left GIP driver is connected to an odd numbered scan line, and a right GIP driver is connected to an even numbered scan line. Such a display device can have a limitation in that image quality is degraded due to a difference between an output input to a position far away from the left or right GIP driver and an output input to a position closer to the left or right GIP driver in an edge area of the display panel.

In addition, in a display device including a double feeding-type GIP driver, the number of scans in a DRD (double rate driving)-type display device is two times of that in a single rate driving (SRD)-type display device, and thus the number of GIP drivers in the former device is two times of that in the latter device. Thus, the GIP driver dimension in the DRD type device needs to be reduced to ½ compared to the SRD type device, such that there is a limitation in that the output characteristics thereof can further be deteriorated.

In addition, a small and medium-sized display panel can have difficulty in designing a more reduced GIP driver when the double feeding type GIP driver is applied to a high pixels per inch (PPI) or DRD type display device under a narrow bezel.

Accordingly, the inventors of the present disclosure have invented an improved gate driving circuit suitable for a high PPI or DRD scheme and a display device including the same.

A purpose of the present disclosure is to provide a gate driving circuit suitable for a high PPI or DRD scheme and a display device including the same.

In addition, a purpose of the present disclosure is to provide a gate driving circuit capable of improving image quality without degrading image quality even when being applied to a high-PPI or DRD scheme, and a display device including the same

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof.

A display device according to an embodiment of the present disclosure includes: a display panel including a plurality of scan lines; a first GIP (gate-in-panel) driver and a second GIP driver respectively disposed on both opposing sides of the display panel, wherein each of the first GIP driver and the second GIP driver is configured to sequentially output a scan signal; a first transfer circuit disposed between and connected to the display panel and the first GIP driver and configured to transfer the scan signal of the first GIP driver selectively to a first scan line and a second scan line among the plurality of scan lines; and a second transfer circuit disposed between and connected to the display panel and the second GIP driver and configured to transfer the scan signal of the second GIP driver selectively to the first scan line and the second scan line.

According to some embodiments, for a first frame, the first transfer circuit is configured to transfer the scan signal output from the first GIP driver to one of the first scan line and the second scan line, and the second transfer circuit is configured to transfer the scan signal output from the second GIP driver to the other of the first scan line and the second scan line, wherein for a second frame subsequent to the first frame, the first transfer circuit is configured to transfer the scan signal output from the first GIP driver to the other of the first scan line and the second scan line, and the second transfer circuit is configured to transfer the scan signal output from the second GIP driver to the one of the first scan line and the second scan line.

A gate driving circuit according to an embodiment of the present disclosure includes a first GIP driver disposed on a left side (e.g., first side) of a display panel, and a second GIP driver disposed on a right side (e.g., second side) of the display panel, wherein a scan signal of the first GIP driver is transferred to an odd-numbered scan line among a plurality of scan lines for an n-th frame, and is transferred to an even-numbered scan line for an (n+1)-th frame, where n is a positive integer, wherein a scan signal of the second GIP driver is transferred to the even-numbered scan line for the n-th frame, and is transferred to the odd-numbered scan line for the (n+1)-th frame.

A display device according to another embodiment of the present disclosure includes a display panel including a plurality of scan lines and a plurality of sensing lines; a first GIP driver and a second GIP driver respectively disposed on both opposing sides of the display panel, wherein each of the first GIP driver and the second GIP driver is configured to sequentially output a scan signal and sequentially output a sensing signal to the display panel; a first transfer circuit configured to alternately transfer the scan signal of the first GIP driver to a first scan line and a second scan line among the plurality of scan lines, and to alternately transfer the sensing signal of the first GIP driver to a first sensing line and a second sensing line among the plurality of sensing lines; and a second transfer circuit configured to alternately transfer the scan signal of the second GIP driver to the first scan line and the second scan line, and to alternately transfer the sensing signal of the second GIP driver to the first sensing line and the second sensing line.

According to embodiments of the present disclosure, in the display device, for the same frame, one of the scan signal output terminals of the first GIP driver and the second GIP driver is selectively connected to one of the odd-numbered scan line and the even-numbered scan line among the plurality of scan lines, while the other of the scan signal output terminals of the first GIP driver and the second GIP driver is selectively connected to the other of the odd-numbered scan line and the even-numbered scan line among the plurality of scan lines. Conventionally, the image quality can be degraded due to a difference between an output input to a position far away from the left or right GIP driver and an output input to a position closer to the left or right GIP driver in an edge area of the display panel. However, using the above configuration of the present disclosure, the difference can be removed such that the brightness of the display panel can be maintained at the average luminance in the edge area.

In addition, according to embodiments of the present disclosure, for the same frame, the display device connects one of the sensing signal output terminals of the first GIP driver and the second GIP driver to one of the odd-numbered sensing line and the even-numbered sensing line among the plurality of sensing lines, and connects the other of the sensing signal output terminals of the first GIP driver and the second GIP driver to the other of the odd-numbered sensing line and the even-numbered sensing line among the plurality of sensing lines. Conventionally, the image quality can be degraded due to a difference between an output input to a position far away from the left or right GIP driver and an output input to a position closer to the left or right GIP driver in an edge area of the display panel. However, using the above configuration of the present disclosure, the difference can be removed such that the brightness of the display panel can be maintained at the average luminance in the edge area.

In addition, according to embodiments of the present disclosure, the display device connects the respective outputs of the first GIP driver 300a and the second GIP driver selectively to two scan lines, respectively. Thus, there is no need to reduce the GIP driver dimension by ½, thereby improving output characteristics compared to the existing DRD scheme.

In addition, according to embodiments of the present disclosure, the display device connects the respective outputs of the first GIP driver and the second GIP driver selectively to the two scan lines, thereby facilitating the GIP driver design of the small and medium-sized display panel having the high PPI or DRD scheme.

In addition, according to embodiments of the present disclosure, the display device outputs one of the scan signals of the first GIP driver and the second GIP driver to one of the odd-numbered scan line and the even-numbered scan line and outputs the other of the scan signals of the first GIP driver and the second GIP driver to the other of the odd-numbered scan line and the even-numbered scan line for one of two consecutive frames, and outputs one of the scan signals of the first GIP driver and the second GIP driver to the other of the odd-numbered scan line and the even-numbered scan line and outputs the other of the scan signals of the first GIP driver and the second GIP driver to one of the odd-numbered scan line and the even-numbered scan line for the other of two consecutive frames. Thus, the brightness and darkness levels of the pixels are uniform, thereby preventing occurrence of a defect in a shape of a column line.

In addition, according to embodiments of the present disclosure, the display device outputs one of the scan signals of the first GIP driver 300a and the second GIP driver to one of the odd-numbered scan line and the even-numbered scan line and outputs the other of the scan signals of the first GIP driver and the second GIP driver to the other of the odd-numbered scan line and the even-numbered scan line for one of two consecutive frames, and outputs one of the scan signals of the first GIP driver and the second GIP driver to the other of the odd-numbered scan line and the even-numbered scan line and outputs the other of the scan signals of the first GIP driver and the second GIP driver to one of the odd-numbered scan line and the even-numbered scan line for the other of two consecutive frames, such that the display device can improve the image quality.

In addition, according to embodiments of the present disclosure, the display device connects the respective outputs of the first GIP driver and the second GIP driver selectively to two scan lines, respectively. Thus, it is not necessary to reduce the GIP driver dimension, and thus the display device DD can be appropriately applied to a high-PPI or DRD type display panel.

Effects of the present disclosure are not limited to the effects mentioned above, and other effects not mentioned will be clearly understood by those skilled in the art from the description as set forth below.

In addition to the above effects, specific effects of the present disclosure are described together while describing specific details for carrying out the present disclosure.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a block diagram illustrating an organic light-emitting display device according to an embodiment of the present disclosure.

FIG. 2 is an example diagram illustrating an organic light-emitting display device according to an embodiment of the present disclosure.

FIG. 3 is a circuit diagram of an example of a pixel included in an organic light-emitting display device according to an embodiment of the present disclosure.

FIG. 4 is a circuit diagram of an example of a gate driver included in an organic light-emitting display device according to an embodiment of the present disclosure.

FIG. 5 is a circuit diagram of another example of a gate driver included in an organic light-emitting display device according to an embodiment of the present disclosure.

FIG. 6 is a circuit diagram of another example of a pixel included in an organic light-emitting display device according to an embodiment of the present disclosure.

FIG. 7 is a circuit diagram of still another example of a gate driver included in an organic light-emitting display device according to an embodiment of the present disclosure.

FIG. 8 is a plan view of a display panel included in an organic light-emitting display device according to an embodiment of the present disclosure.

### DETAILED DESCRIPTION OF THE EMBODIMENTS

Advantages and features of the present disclosure, and a method of achieving the advantages and features will become apparent with reference to embodiments described below in detail together with the accompanying drawings. However, the present disclosure is not limited to the embodiments as disclosed under, but can be implemented in various different forms. Thus, these embodiments are set forth only to make the present disclosure complete, and to entirely inform the scope of the present disclosure to those of ordinary skill in the technical field to which the present disclosure belongs.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as can be included within the spirit and scope of the present disclosure as defined by the appended claims.

A shape, a size, a ratio, an angle, a number, etc., disclosed in the drawings for illustrating embodiments of the present disclosure are illustrative, and the present disclosure is not limited thereto. The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements can modify an entirety of the list of elements and may not modify the individual elements of the list.

In interpretation of numerical values, an error or tolerance therein can occur even when there is no explicit description thereof.

In addition, it will also be understood that when a first element or layer is referred to as being present “on” a second element or layer, the first element can be disposed directly on the second element or can be disposed indirectly on the second element with a third element or layer being disposed between the first and second elements or layers. It will be understood that when a first element or layer is referred to as being “connected to”, or “coupled to” a second element or layer, the first element can be directly connected to or coupled to the second element or layer, or one or more intervening elements or layers can be present therebetween. In addition, it will also be understood that when an element or layer is referred to as being “between” two elements or layers, it can be the only element or layer between the two elements or layers, or one or more intervening elements or layers can also be present therebetween.

Further, as used herein, when a layer, film, area, plate, or the like is disposed “on” or “on a top” of another layer, film, area, plate, or the like, the former can directly contact the latter or still another layer, film, area, plate, or the like can be disposed between the former and the latter. As used herein, when a layer, film, area, plate, or the like is directly disposed “on” or “on a top” of another layer, film, area, plate, or the like, the former directly contacts the latter and still another layer, film, area, plate, or the like is not disposed between the former and the latter. Further, as used herein, when a layer, film, area, plate, or the like is disposed “below” or “under” another layer, film, area, plate, or the like, the former can directly contact the latter or still another layer, film, area, plate, or the like can be disposed between the former and the latter. As used herein, when a layer, film, area, plate, or the like is directly disposed “below” or “under” another layer, film, area, plate, or the like, the former directly contacts the latter and still another layer, film, area, plate, or the like is not disposed between the former and the latter.

In descriptions of temporal relationships, for example, temporal precedent relationships between two events such as “after”, “subsequent to”, “before”, etc., another event can occur therebetween unless “directly after”, “directly subsequent” or “directly before” is not indicated. When a certain embodiment can be implemented differently, a function or an operation specified in a specific block can occur in a different order from an order specified in a flowchart. For example, two blocks in succession can be actually performed substantially concurrently, or the two blocks can be performed in a reverse order depending on a function or operation involved.

It will be understood that, although the terms “first”, “second”, “third”, and so on can be used herein to describe various elements, components, areas, layers and/or periods, these elements, components, areas, layers and/or periods should not be limited by these terms. These terms are used to distinguish one element, component, area, layer or section from another element, component, area, layer or section. Thus, a first element, component, area, layer or section as described under could be termed a second element, component, area, layer or section, without departing from the spirit and scope of the present disclosure.

When an embodiment can be implemented differently, functions or operations specified within a specific block can be performed in a different order from an order specified in a flowchart. For example, two consecutive blocks can actually be performed substantially simultaneously, or the blocks can be performed in a reverse order depending on related functions or operations.

The features of the various embodiments of the present disclosure can be partially or entirely combined with each other, and can be technically associated with each other or operate with each other. The embodiments can be implemented independently of each other and can be implemented together in an association relationship.

In interpreting a numerical value, the value is interpreted as including an error range unless there is no separate explicit description thereof. Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, etc. should not be construed such that any aspect or design as described is superior to or advantageous over other aspects or designs. Further, the term ‘or’ means ‘inclusive or’ rather than ‘exclusive or’. That is, unless otherwise stated or clear from the context, the expression that ‘x uses a or b’ means one of natural inclusive permutations.

The terms used in the description as set forth below have been selected as being general and universal in the related technical field. However, there can be other terms than the terms depending on the development and/or change of technology, convention, preference of technicians, etc. Therefore, the terms used in the description as set forth below should not be understood as limiting technical ideas, but should be understood as examples of the terms for illustrating embodiments. Further, in a specific case, a term can be arbitrarily selected by the applicant, and in this case, the detailed meaning thereof will be described in a corresponding description period. Therefore, the terms used in the description as set forth below should be understood based on not simply the name of the terms, but the meaning of the terms and the contents throughout the Detailed Description.

In description of flow of a signal, for example, when a signal is delivered from a node A to a node B, this can include a case where the signal is transferred from the node A to the node B via another node unless a phrase ‘immediately transferred’ or ‘directly transferred’ is used. Throughout the present disclosure, “A and/or B” means A, B, or A and B, unless otherwise specified, and “C to D” means C inclusive to D inclusive unless otherwise specified.

As used herein, a first direction, a second direction, and a third direction, or an X-axis direction, a Y-axis direction, and a Z-axis direction should not be interpreted only as having a geometric relationship with each other in which the first direction, the second direction, and the third direction are perpendicular to each other or the X-axis direction, the Y-axis direction, and the Z-axis direction are perpendicular to each other, but can be interpreted as having a geometric relationship with each other in which the first direction, the second direction, and the third direction interest each other at an angle other than 90 degrees or the X-axis direction, the Y-axis direction, and the Z-axis direction are interest each other at an angle other than 90 degrees within a range in which a configuration of the present disclosure can work functionally. In a plan view of the display device, a column direction and a row direction intersecting each other are used to define an extension direction of a component, for example, a line. Further, the term “can” fully encompasses all the meanings and coverages of the “may” and vice versa.

Hereinafter, various embodiments of the present disclosure will be described in detail with reference to the accompanying drawings. All the components of each display device according to all embodiments of the present disclosure are operatively coupled and configured.

Hereinafter, a gate driving circuit suitable for a high PPI or DRD scheme according to an embodiment of the present disclosure and a display device including the same will be described.

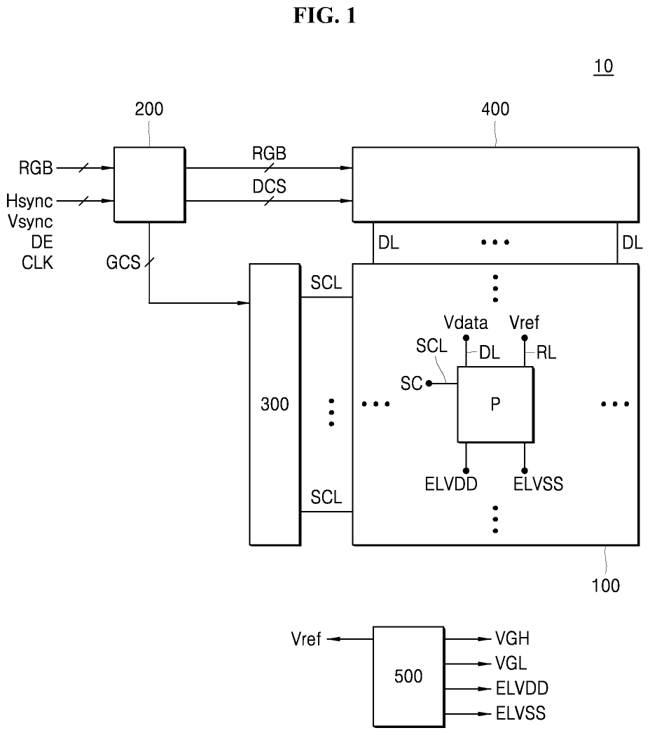

FIG. 1 is a block diagram illustrating an organic light-emitting display device according to an embodiment of the present disclosure.

Referring to FIG. 1, a display device 10 includes a display panel 100 including a plurality of pixels P, a controller 200, a gate driver 300 configured to supply a scan signal SC to the plurality of pixels P, a data driver 400 configured to supply a data voltage Vdata to the plurality of pixels P, and a power supply 500 configured to supply voltages necessary for driving the plurality of pixels P.

In the display panel 100, a plurality of scan lines SCL and a plurality of data lines DL intersect each other, and each of the plurality of pixels P is connected to the scan line SCL and the data line DL. Each of the plurality of data lines DL may be configured to extend in a first direction. Each of the plurality of scan lines SCL may be configured to extend in a second direction different from the first direction.

Specifically, one pixel P receives the scan signal SC through the scan line SCL, receives the data voltage Vdata through the data line DL, and receives a reference voltage Vref, a high potential driving voltage ELVDD, and a low potential driving voltage ELVSS from the power supply 500.

The scan line SCL supplies the scan signal SC and the sensing signal to the pixel P, and the data line DL supplies the data voltage Vdata to the pixel P. In addition, according to various embodiments, a sensing line for supplying the sensing signal can be connected to the scan line SCL and can be individually connected to the pixel P.

In addition, the plurality of pixels P can receive the high-potential driving voltage ELVDD and the low-potential driving voltage ELVSS via the power lines to and can receive the reference voltage Vref via a reference voltage line RL.

For example, the power supply 500 outputs the high-potential driving voltage ELVDD and the low-potential driving voltage ELVSS etc., on the basis of an external input voltage supplied from the outside, to supply these to the plurality of pixels P.

In addition, each of the pixels P includes a light-emitting element and a pixel circuit for controlling driving of the light-emitting element. The pixel circuit includes a plurality of switching elements, a driving element, and a capacitor. For example, the pixel circuit can be composed of 3T1C, 4T1C, 5T1C, 6T1C, 7T1C, 3T2C, 4T2C, 5T2C, 6T2C, 7T2C, 8T2C, etc., but is not limited thereto. In this regard, each of the switching element and the driving element can be embodied as a thin-film transistor. In the pixel circuit, the driving element controls the amount of current supplied to the light-emitting element according to the data voltage to adjust the amount of light emitted from the light-emitting element. In addition, the plurality of switching elements receive the scan signal SC supplied through the plurality of scan lines SCL and the reference voltage Vref supplied through the reference voltage line RL and operate the pixel circuit based on the received scan signal the received reference voltage.

The display panel 100 can be implemented as a non-transmissive display panel or a transmissive display panel. The transmissive display panel can be applied to a transparent display device in which an image is displayed on a screen and a real object in the background is visible to a viewer in front of the display device. The display panel 100 can be manufactured as a flexible display panel. The flexible display panel can be implemented as an OLED panel using a plastic substrate.

The pixels P can include a red pixel, a green pixel, and a blue pixel. Each of the pixels P can further include a white pixel.

Touch sensors TS can be disposed on the display panel 100. The touch input can be sensed using separate touch sensors or can be sensed via the pixels P. The touch sensor can be implemented as an on-cell type touch sensor or an add-on type touch sensor in which the touch sensor is disposed on the screen of the display panel or as an in-cell type touch sensor in which the touch sensor is embedded in the display panel 100.

The controller 200 processes image data RGB input from a host system to be suitable for the size and a resolution of the display panel 100 and supplies the processed image data RGB to the data driver 400. The controller 200 generates a gate control signal GCS and a data control signal DCS using synchronization signals input from an external source, for example, a clock signal CLK, a data enable signal DE, a horizontal synchronization signal Hsync, and a vertical synchronization signal Vsync. The gate control signal GCS and the data control signal DCS are supplied to the gate driver 300 and the data driver 400, respectively, to control the gate driver 300 and the data driver 400.

A voltage level of the gate control signal GCS output from the controller 200 can be converted into a gate-on voltage and a gate-off voltage through a level shifter and can be supplied to the gate driver 300. The level shifter converts the low level voltage of the gate control signal GCS into a gate low voltage VGL, and converts the high level voltage of the gate control signal GCS into a gate high voltage VGH. The gate control signal GCS includes a start pulse and a shift clock.

The gate driver 300 supplies the scan signal SC to the scan line SCL according to the gate control signal GCS. The gate driver 300 can be disposed on one side or each of both opposing sides of the display panel 100 in a gate-in-panel (GIP) manner.

The gate driver 300 sequentially outputs the scan signal SC to the plurality of scan lines SCL. The gate driver 300 can sequentially supply the scan signal SC to the scan line SCL by shifting the scan signal SC using a shift register. The scan signal SC can include a scan signal that swings between the gate low voltage VGL and the gate high voltage VGH. In addition, according to various embodiments, the gate driver 300 sequentially outputs the sensing signal to the plurality of sensing lines SL. The sensing signal can include a scan signal that swings between the gate low voltage VGL and the gate high voltage VGH.

The gate driver 300 outputs the scan signal SCP in response to the start pulse and the shift clock from the controller 200, and sequentially shifts the scan signal according to the shift clock.

The data driver 400 converts the image data RGB into a data voltage Vdata according to the data control signal DCS, and supplies the converted data voltage Vdata to the pixel P through the data line DL.

Although FIG. 1 illustrates that the data driver 400 is disposed in a single manner and on one side of the display panel 100, the number and arrangement position of the data driver 400 are not limited thereto. That is, the data driver 400 can be composed of a plurality of integrated circuits (IC) which can be disposed on one side of the display panel 100.

The power supply 500 generates DC power required for driving the pixel array of the display panel 100, the gate driver 300, and the data driver 400. The power supply 500 can include a charge pump, a regulator, a buck converter, a boost converter, etc.

The power supply 500 can receive an input power from the host system and can generate a DC voltage such as the gate high voltage VGH, the gate low voltage VGL, the high potential driving voltage ELVDD, the low potential driving voltage ELVSS, and the reference voltage Vref. The gate low voltage VGL and the gate high voltage VGH can be supplied to the gate driver 300, and the high potential driving voltage ELVDD, the low potential driving voltage ELVSS, and the reference voltage Vref can be supplied to the pixels P.

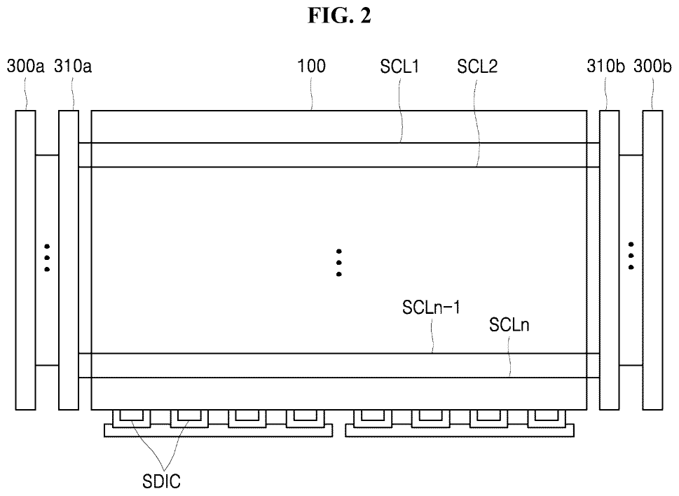

FIG. 2 is an example diagram illustrating an organic light-emitting display device according to an embodiment of the present disclosure.

Referring to FIG. 2, the display device includes a display panel 100 and a first GIP driver 300a and a second GIP driver 300b respectively disposed on both opposing sides of the display panel 100. The first GIP driver 300a is disposed on the left side of the display panel 100, and the second GIP driver 300b is disposed on the right side of the display panel 100.

In addition, the display device further includes a first transfer circuit 310a disposed between and connected to the display panel 100 and the first GIP driver 300a and a second transfer circuit 310b disposed between and connected to the display panel 100 and the second GIP driver 300b.

In the present disclosure, the gate driver 300 can include a gate driving circuit, and the gate driving circuit can include the first GIP driver 300a, the second GIP driver 300b, the first transfer circuit 310a, and the second transfer circuit 310b.

Each of the first GIP driver 300a and the second GIP driver 300b can sequentially output the scan signal SC to the plurality of scan lines SCL1, SCL2, to SCLn by shifting the scan signal SC using a shift register including a plurality of stages.

The first transfer circuit 310a connects one of a plurality of outputs of the first GIP driver 300a selectively to two of the plurality of scan lines SCL1, SCL2, to SCLn. In this regard, the output of the first GIP driver 300a can be defined as an output terminal through which the scan signal is output. For example, the first transfer circuit 310a can alternately connect the output of the first GIP driver 300a to an odd-numbered scan line SL1 and an even-numbered scan line SL1 for two consecutive frames.

The second transfer circuit 310b connects one of the plurality of outputs of the second GIP driver 300b selectively to two scan lines among the plurality of scan lines SCL1, SCL2, to SCLn. In this regard, the output of the second GIP driver 300b can be defined as an output terminal through which the scan signal is output. For example, the second transfer circuit 310b can alternately connect the output of the second GIP driver 300b to the even-numbered scan line SL2 and the odd-numbered scan line SL22 for two consecutive frames.

Alternatively, the first transfer circuit 310a can alternately output the scan signals of outputs of the first GIP driver 300a to the odd-numbered scan line and the odd-numbered scan line for consecutive frames and can alternately output the sensing signals of outputs of the first GIP driver 300a to the odd-numbered sensing line and the odd-numbered sensing line for consecutive frames. The second transfer circuit 310b can alternately output the scan signals of outputs of the second GIP driver 300b to the odd-numbered scan line and the odd-numbered scan line for consecutive frames and can alternately output the sensing signals of outputs of the second GIP driver 300b to the odd-numbered sensing line and the odd-numbered sensing line for consecutive frames.

In FIG. 2, undescribed reference numeral SDIC denotes a source driver. The data driver 400 can include a plurality of source drivers SDIC. Each of the source drivers SDIC changes the image data RGB into a data voltage and supplies the converted data voltage to the pixel PX through the data line DL.

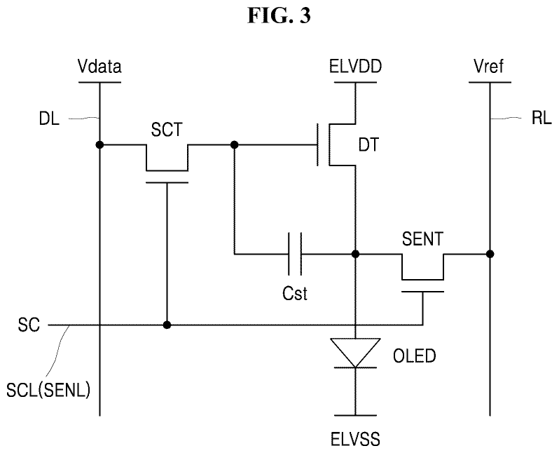

FIG. 3 is a circuit diagram of an example of a pixel included in an organic light-emitting display device according to an embodiment of the present disclosure.

Referring to FIG. 3, the pixel PX is defined by the scan line SCL, the data line DL, the power line, and the reference voltage line RL. A scan transistor SCT, a driving transistor DT, a light-emitting element OLED, a sensing transistor SENT, and a storage capacitor Cst are disposed in one pixel.

The scan transistor SCT functions to select a pixel to be driven by applying the data voltage Vdata to the driving transistor DT. The scan transistor SCT is disposed in an area where the scan line SCL and the data line DL intersect each other. The scan transistor SCT includes a gate electrode, a source electrode, and a drain electrode. The gate electrode is connected to the scan line SCL. The source electrode is connected to the data line DL, and the drain electrode is connected to the driving transistor DT.

The driving transistor DT functions to drive the light-emitting element OLED of the pixel selected by the scan transistor SCT. The driving transistor DT includes a gate electrode, a source electrode, and a drain electrode. The gate electrode is connected to the drain electrode SD of the scan transistor SCT, the source electrode is connected to the power line to which the high potential driving voltage ELVDD is applied, and the drain electrode is connected to an anode electrode of the light-emitting element OLED.

The storage capacitor Cst serves to sample the data voltage Vdata. The storage capacitor Cst includes one electrode and the other electrode. One electrode of the storage capacitor Cst is connected to a node between the drain electrode of the scan transistor SCT and the gate electrode of the driving transistor DT, and the other electrode of the storage capacitor Cst is connected to a node between the drain electrode of the driving transistor DT and the anode electrode of the light-emitting element OLED.

The light-emitting element OLED is configured to emit light by itself, and the intensity of light emission of light emitted therefrom is adjusted according to the amount of current flowing therein. For example, the light-emitting element OLED can be embodied as an organic light-emitting diode. The light-emitting element OLED includes the anode electrode, a light-emitting layer, and a cathode electrode. The anode electrode of the light-emitting element OLED is connected to the drain electrode of the driving transistor DT and the other electrode of the storage capacitor Cst, the cathode electrode of the light-emitting element OLED is connected to the power line to which the low-potential driving voltage ELVSS is applied, and the light-emitting layer is disposed between the anode electrode and the cathode electrode.

The sensing transistor SENT is used to initialize the anode electrode of the light-emitting element OLED and the other electrode of the storage capacitor Cst with the reference voltage Vref or to sense pixel characteristics. The sensing transistor SENT includes a gate electrode, a source electrode, and a drain electrode. A gate electrode of the sensing transistor SENT is connected to the scan line SCL, and a drain electrode of the sensing transistor SENT is connected to the anode electrode of the light-emitting element OLED, the drain electrode of the driving transistor DT, and the other electrode of the storage capacitor Cst. The source electrode of the sensing transistor SENT is connected to the reference voltage line RL. According to various embodiments, the gate electrode of the sensing transistor SENT can be connected to the sensing line that supplies a separate sensing signal.

The driving transistor DT adjusts the amount of current flowing through the light-emitting element OLED based on a magnitude of the data voltage Vdata.

In addition, according to some embodiments, at least one of the transistors of the pixel circuit can be formed as a P-type thin-film transistor or a N-type thin-film transistor. Each of the transistors including the driving transistor can be made of, for example, LTPS, oxide, single-silicon, or an organic material. The light-emitting element OLED can be embodied as a self-emitting diode such as an organic light-emitting element or a micro LED. The substrate on which the pixel PX is formed can be embodied as a glass substrate, a plastic substrate, a flexible plastic substrate, a wafer, or the like.

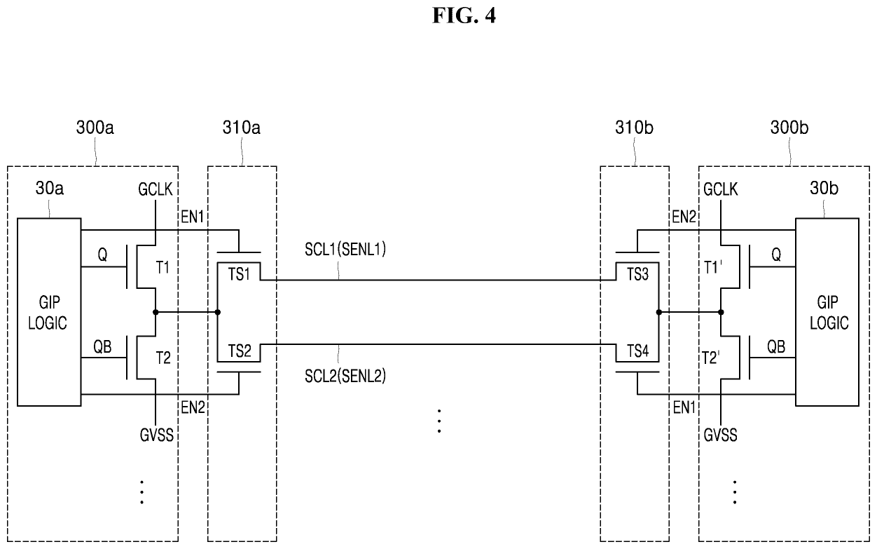

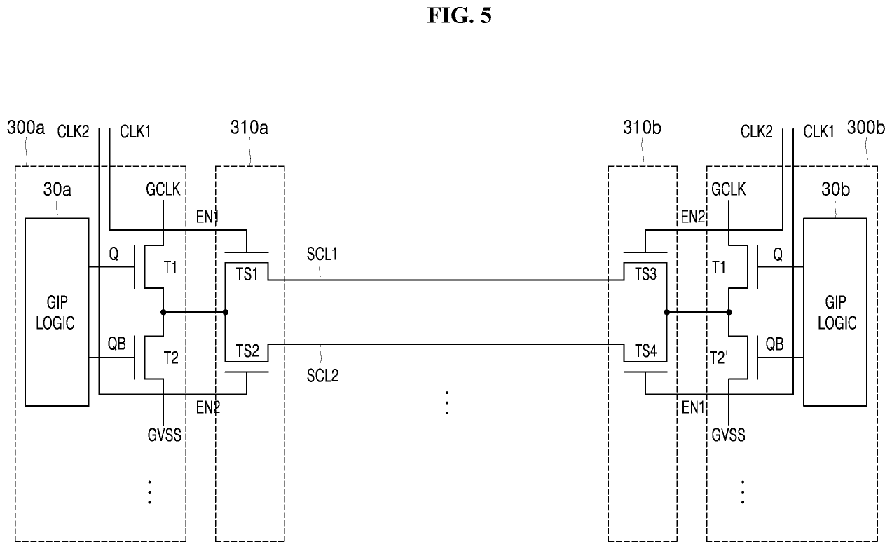

FIG. 4 is a circuit diagram of an example of a gate driver included in an organic light-emitting display device according to an embodiment of the present disclosure. FIG. 5 is a circuit diagram of another example of a gate driver of included in an organic light-emitting display device according to an embodiment of the present disclosure.

In FIGS. 4 and 5, one output of each of the first GIP driver 300a and the second GIP driver 300b and two scan lines are illustrated. However, this is illustrated for convenience of illustration, and each of the first GIP driver 300a and the second GIP driver 300b includes a plurality of outputs, and each of the plurality of outputs can be selectively connected to the two scan lines.

Referring to FIG. 4, the display device includes the first GIP driver 300a and the second GIP driver 300b. Each of the first GIP driver 300a and the second GIP driver 300b can include a plurality of stages for sequentially supplying the scan signal to the plurality of scan lines. FIG. 4 illustrates one stage among the plurality of stages for convenience of illustration.

Each of the plurality of stages of the first GIP driver 300a includes a logic circuit 30a, a pull-up transistor T1, and a pull-down transistor T2.

The logic circuit 30a outputs a first driving signal to a Q node and outputs a second driving signal to a QB node. The pull-up transistor T1 can pull-up the output of the first GIP driver 300a in response to the first driving signal. The pull-down transistor T2 can pull-down the output of the first GIP driver 300a in response to the second drive signal.

The pull-up transistor T1 has a gate electrode connected to the Q node, a source electrode connected to a line to which a global clock GCLK is applied, and a drain electrode connected to an output terminal. The pull-up transistor T1 outputs the scan signal including a scan pulse at a time point at which the first driving signal at a high logic level is applied to the Q node and the global clock GCLK at a high logic level is applied thereto.

The pull-down transistor T2 has a gate electrode connected to the QB node, a source electrode connected to a line to which a global low potential voltage GVSS is applied, and a drain electrode connected to an output terminal. The pull-down transistor T2 outputs the scan signal at a low logic level while the second driving signal at a high logic level is applied to the QB node.

Likewise, each of the plurality of stages of the second GIP driver 300b includes a logic circuit 30b, a pull-up transistor T1′, and a pull-down transistor T2′. The logic circuit 30b outputs the first driving signal to the Q node and outputs the second driving signal to the QB node. The pull-up transistor T1′ pulls-up the output of the second GIP driver 300b in response to the first driving signal. The pull-down transistor T2′ pulls-down the output of the second GIP driver 300b in response to the second driving signal.

For example, the pull-up transistor T1′ outputs the scan signal including a scan pulse at a time point at which the first driving signal at a high logic level is applied to the Q node and the global clock GCLK at a high logic level is applied thereto. For example, the pull-down transistor T2′ outputs the scan signal at a low logic level while the second driving signal at a high logic level is applied to the QB node.

In addition, the display device DD includes the first transfer circuit 310a and the second transfer circuit 310b. The first transfer circuit 310a is disposed between and connected to the display panel DP and the first GIP driver 300a and is configured to connect the output of the first GIP driver 300a selectively to the odd-numbered sensing line and the odd-numbered sensing line, such as the first scan line SCL1 and the second scan line SCL2.

The second transfer circuit 310b is disposed between and connected to the display panel DP and the second GIP driver 300b and is configured to connect the output of the second GIP driver 300b selectively to the odd-numbered scan line and the even-numbered scan line, such as the first scan line SCL1 and the second scan line SCL2 among the plurality of scan lines. In this regard, the first scan line SCL1 can be an odd-numbered scan line among the plurality of scan lines, and the second scan line SCL2 can be an even-numbered scan line among the plurality of scan lines.

For first and second fames sequentially occurring, the first transfer circuit 310a can alternately transfer the scan signal output from the first GIP driver 300a to the first scan line and the second scan line while the second transfer circuit 310b can alternately transfer the scan signal output from the second GIP driver 300b to the first scan line and the second scan line, such that for the first frame, the scan signal output from the first GIP driver 300a is transferred to one of the first scan line and the second scan line while the scan signal output from the second GIP driver 300b is transferred to the other of the first scan line and the second scan line, and for the second frame, the scan signal output from the first GIP driver 300a is transferred to the other of the first scan line and the second scan line while the scan signal output from the second GIP driver 300b is transferred to one of the first scan line and the second scan line.

In other words, for a first frame, the first transfer circuit 310a is configured to transfer the scan signal output from the first GIP driver 300a to one of the first scan line SCL1 and the second scan line SCL2, and the second transfer circuit 310b is configured to transfer the scan signal output from the second GIP driver 300b to the other of the first scan line SCL1 and the second scan line SCL2, wherein for a second frame subsequent to the first frame, the first transfer circuit 310a is configured to transfer the scan signal output from the first GIP driver 300a to the other of the first scan line SCL1 and the second scan line SCL2, and the second transfer circuit 310b is configured to transfer the scan signal output from the second GIP driver 300b to one of the first scan line SCL1 and the second scan line SCL2.

For example, for an odd-numbered frame, the first transfer circuit 310a may transfer a scan signal of the first GIP driver 300a to the odd-numbered scan line among the plurality of scan lines, and the second transfer circuit 310b may transfer a scan signal of the second GIP driver 300b to the even-numbered scan line among the plurality of scan lines.

For example, for an odd-numbered frame, the first transfer circuit 310a can transfer a scan signal of the first GIP driver 300a to the first scan line SCL1, and the second transfer circuit 310b can transfer a scan signal of the second GIP driver 300b to the second scan line SCL2.

For example, for an even-numbered frame, the first transfer circuit 310a may transfer the scan signal of the first GIP driver 300a to the even-numbered scan line among the plurality of scan lines, and the second transfer circuit 310b may transfer the scan signal of the second GIP driver 300b to the odd-numbered scan line among the plurality of scan lines.

For example, for an even-numbered frame, the first transfer circuit 310a can transfer the scan signal of the first GIP driver 300a to the second scan line SCL2, and the second transfer circuit 310b can transfer the scan signal of the second GIP driver 300b to the first scan line SCL1.

The first transfer circuit 310a includes a first transfer transistor TS1 and a second transfer transistor TS2. The first transfer transistor TS1 outputs a scan signal of the first GIP driver 300a to the first scan line SCL1 in response to the first enable signal EN1. The second transfer transistor TS2 outputs the scan signal of the first GIP driver 300a to the second scan line SCL2 in response to the second enable signal EN2.

A gate electrode of the first transfer transistor TS1 is connected to a line to which the first enable signal EN1 is applied, a drain electrode thereof is connected to an output terminal of the first GIP driver 300a, and a source electrode thereof is connected to the first scan line SCL1.

A gate electrode of the second transfer transistor TS2 is connected to a line to which the second enable signal EN2 is applied, a drain electrode thereof is connected to an output terminal of the first GIP driver 300a, and a source electrode thereof is connected to the second scan line SCL2.

The second transfer circuit 310b includes a third transfer transistor TS3 and a fourth transfer transistor TS4. The third transfer transistor TS3 outputs a scan signal of the second GIP driver 300b to the first scan line SCL1 in response to the second enable signal EN2. The fourth transfer transistor TS4 outputs the scan signal of the second GIP driver 300b to the second scan line SCL2 in response to the first enable signal EN1.

A gate electrode of the third transfer transistor TS3 is connected to a line to which the second enable signal EN2 is applied, a drain electrode thereof is connected to an output terminal of the second GIP driver 300b, and a source electrode thereof is connected to the first scan line SCL1.

A gate electrode of the fourth transfer transistor TS4 is connected to a line to which the first enable signal EN1 is applied, a drain electrode thereof is connected to an output terminal of the second GIP driver 300b, and a source electrode thereof is connected to the second scan line SCL2.

The first enable signal EN1 and the second enable signal EN2 are alternately enabled for two consecutive frames. For example, the first enable signal EN1 can be enabled for the odd-numbered frame. The first transfer transistor TS1 and the fourth transfer transistor TS4 can be turned on for the odd-numbered frame in response to the first enable signal EN1. For the odd-numbered frame, the first transfer transistor TS1 transfers the scan signal of the first GIP driver 300a to the first scan line SCL1 in response to the first enable signal EN1, and the fourth transfer transistor TS4 transfers the scan signal of the second GIP driver 300b to the second scan line SCL2 in response to the first enable signal EN1.

Further, for example, the second enable signal EN2 can be enabled for the even-numbered frame. The second transfer transistor TS2 and the third transfer transistor TS3 can be turned on for the even-numbered frame in response to the second enable signal EN2. For the even-numbered frame, the second transfer transistor TS2 transfers the scan signal of the first GIP driver 300a to the second scan line SCL2 in response to the second enable signal EN2, and the third transfer transistor TS3 transfers the scan signal of the second GIP driver 300b to the first scan line SCL1 in response to the second enable signal EN2.

The first enable signal EN1 and the second enable signal EN2 can have logic levels inverted relative to each other. In addition, the logic levels of the first enable signal EN1 and the second enable signal EN2 can be inverted relative to each other for two consecutive frames. In an example, the first enable signal EN1 and the second enable signal EN2 can be respectively applied from the logic circuits 30a and 30b of the first GIP driver 300a and the second GIP driver 300b, as shown in FIG. 4. For example, the first enable signal EN1 and the second enable signal EN2 applied from the logic circuit 30a may be applied to the first transfer transistor TS1 and the second transfer transistor TS2, and the first enable signal EN1 and the second enable signal EN2 applied from the logic circuit 30b may be applied to the fourth transfer transistor TS4 and the third transfer transistor TS3, as shown in FIG. 4. In another example, the first enable signal EN1 and the second enable signal EN2 can be applied as external clock signals CLK1 and CLK2 from an external source to the display panel as shown in FIG. 5.

According to various embodiments, the first transfer circuit 310a can connect the output of the first GIP driver 300a to the first scan line SCL1 for an n-th frame (n is a positive integer), and can connect the output of the first GIP driver 300a to the second scan line SCL2 for a (n+1)-th frame. In addition, the second transfer circuit 310b can connect the output of the second GIP driver 300b to the second scan line SCL2 for the n-th frame, and can connect the output of the second GIP driver 300b to the first scan line SCL1 for the (n+1)-th frame.

According to various embodiments, in the sub-pixel SP, as illustrated in FIG. 3, the scan line SCL can be connected to the gate electrode of the scan transistor SCT that supplies the data voltage Vdata to the sub-pixel SP, and can be connected to the gate electrode of the sensing transistor SENT that supplies the reference voltage Vref to the sub-pixel SP. For example, the scan line SCL may be connected to the gate electrode of the scan transistor SCT and the gate electrode of the sensing transistor SENT. For example, the scan line SCL can function as a sensing line SENL that applies a sensing signal to the sensing transistor SENT.

Accordingly, the first transfer circuit 310a transfers the sensing signal output from the first GIP driver 300a selectively to one of a first sensing line SENL1 and a second sensing line SENL2. The second transfer circuit 310b transfers the sensing signal output from the second GIP driver 300b selectively to one of the second sensing line SENL2 and the first sensing line SENL1.

For example, for a first frame, the first transfer circuit 310a transfers the sensing signal output from the first GIP driver 300a selectively to one of a first sensing line SENL1 and a second sensing line SENL2. For a second frame subsequent to the first frame, the second transfer circuit 310b transfers the sensing signal output from the second GIP driver 300b selectively to one of the second sensing line SENL2 and the first sensing line SENL1.

According to various embodiments, for a first frame, the first transfer circuit 310a is configured to transfer the scan signal output from the first GIP driver 300a to one of the first sensing line SENL1 and the second sensing line SENL2, and the second transfer circuit 310b is configured to transfer the scan signal output from the second GIP driver 300b to the other of the first sensing line SENL1 and the second sensing line SENL2, wherein for a second frame subsequent to the first frame, the first transfer circuit 310a is configured to transfer the scan signal output from the first GIP driver 300a to the other of the first sensing line SENL1 and the second sensing line SENL2, and the second transfer circuit 310b is configured to transfer the scan signal output from the second GIP driver 300b to one of the first sensing line SENL1 and the second sensing line SENL2.

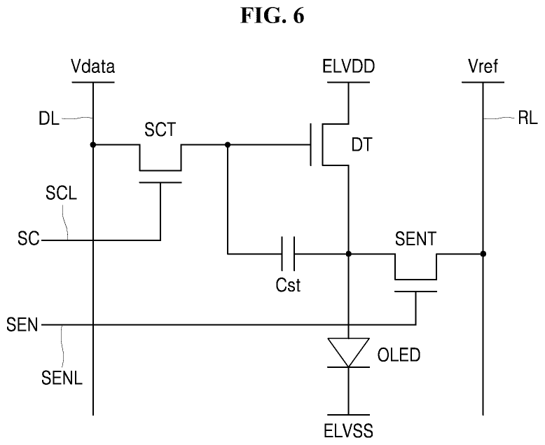

FIG. 6 is a circuit diagram of another example of a pixel included in an organic light-emitting display device according to an embodiment of the present disclosure. In the pixel circuit illustrated in FIG. 6, the scan line SCL and the sensing line SENL are individually disposed therein, compared to the pixel circuit illustrated in FIG. 3.

Specifically, the scan line SCL is connected to the gate electrode of the scan transistor SCT that supplies the data voltage Vdata to the sub-pixel, and the sensing line SENL is connected to the gate electrode of the sensing transistor SENT that supplies the reference voltage Vref to the sub-pixel.

The gate driving circuit applied to the pixel will be described as follows.

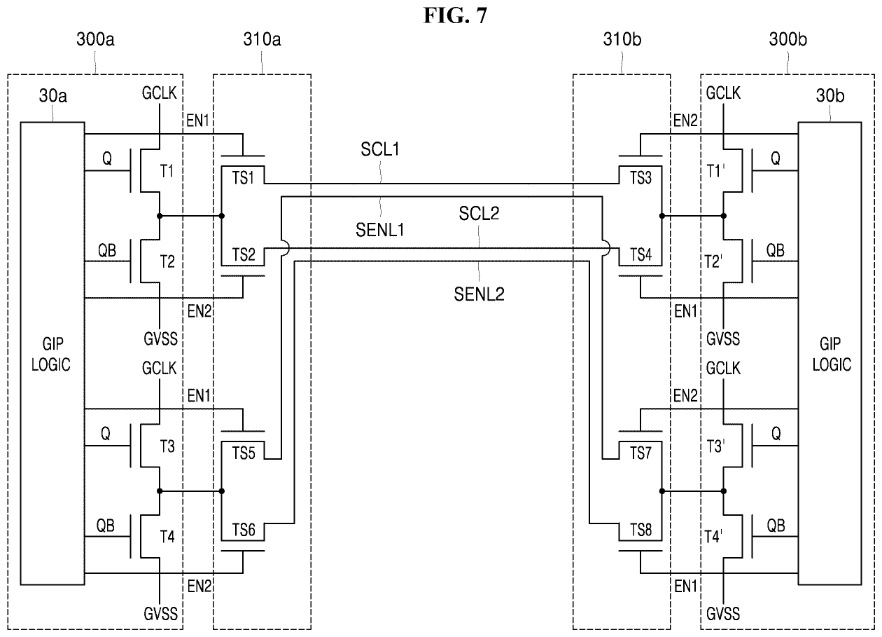

FIG. 7 is a circuit diagram of still another example of a gate driver of included in an organic light-emitting display device according to an embodiment of the present disclosure.

Referring to FIG. 7, the gate driving circuit includes the first GIP driver 300a, the second GIP driver 300b, the first transfer circuit 310a, and the second transfer circuit 310b.

The first GIP driver 300a and the second GIP driver 300b may be respectively disposed on both opposing sides of the display panel DP. The first GIP driver 300a is disposed on the left side of the display panel DP and sequentially outputs the scan signal and the sensing signal SENSE. The second GIP driver 300b is disposed on the right side of the display panel DP and sequentially outputs the scan signal and the sensing signal SENSE.

For example, the first transfer circuit 310a may be disposed on the left side of the display panel DP, and the second transfer circuit 310b may be disposed on the right side of the display panel DP, but is not limited thereto. The first transfer circuit 310a may be disposed between and connected to the display panel DP and the first GIP driver 300a and a second transfer circuit 310b may be disposed between and connected to the display panel DP and the second GIP driver 300b.

The gate driving circuit includes the first GIP driver 300a and the second GIP driver 300b. Each of the first GIP driver 300a and the second GIP driver 300b can include a plurality of stages for sequentially supplying the scan signal to the plurality of scan lines. FIG. 7 illustrates one stage among the plurality of stages for convenience of illustration.

Each of the plurality of stages of the first GIP driver 300a includes the logic circuit 30a, a first pull-up transistor T1, a first pull-down transistor T2, a second pull-up transistor T3, and a second pull-down transistor T4.

The logic circuit 30a outputs the first driving signal to the Q node and outputs the second driving signal to the QB node. The first pull-up transistor T1 pulls-up a scan signal output terminal of the first GIP driver 300a in response to the first driving signal. The first pull-down transistor T2 pulls down a scan signal output terminal of the first GIP driver 300a in response to the second driving signal. The second pull-up transistor T3 pulls-up a sensing signal output terminal of the first GIP driver 300a in response to the first driving signal. The second pull-down transistor T4 pulls down a scan signal output terminal of the first GIP driver 300a in response to the second driving signal.

The first pull-up transistor T1 has a gate electrode connected to the Q node, a source electrode connected to a line to which the global clock GCLK is applied, and a drain electrode connected to the scan signal output terminal. The first pull-up transistor T1 outputs a scan signal including a scan pulse at a point in time when the first driving signal at a high logic level is applied to the Q node and the global clock GCLK at a high logic level is applied thereto.

In the first pull-down transistor T2, a gate electrode is connected to the QB node, a source electrode is connected to a line to which the global low potential voltage GVSS is applied, and a drain electrode is connected to the scan signal output terminal. The first pull-down transistor T2 outputs the scan signal at a low logic level while the second driving signal at a high logic level is applied to the QB node.

For example, the logic circuit 30a outputs the first driving signal to the Q node, the first pull-up transistor T1 pulls-up a scan signal output terminal of the first GIP driver 300a in response to the first driving signal applied to the Q node, and the second pull-up transistor T3 pulls-up a sensing signal output terminal of the first GIP driver 300a in response to the first driving signal applied to the Q node.

For example, the logic circuit 30a outputs the second driving signal to the QB node, the first pull-down transistor T2 pulls down a scan signal output terminal of the first GIP driver 300a in response to the second driving signal applied to the QB node, and the second pull-down transistor T4 pulls down a sensing signal output terminal of the first GIP driver 300a in response to the second driving signal applied to the QB node.

The second pull-up transistor T3 has a gate electrode connected to the Q node, a source electrode connected to a line to which the global clock GCLK is applied, and a drain electrode connected to the sensing signal output terminal. The second pull-up transistor T3 outputs a sensing signal including a sensing pulse at a time point at which the first driving signal at a high logic level is applied to the Q node and the global clock GCLK at a high logic level is applied thereto.

The second pull-down transistor T4 has a gate electrode connected to the QB node, a source electrode connected to a line to which the global low potential voltage GVSS is applied, and a drain electrode connected to the sensing signal output terminal. The second pull-down transistor T4 outputs the sensing signal at a low logic level while the second driving signal at a high logic level is applied to the QB node.

Likewise, each of the plurality of stages of the second GIP driver 300b includes the logic circuit 30b, a first pull-up transistor T1′, a second pull-down transistor T2′, a second pull-up transistor T3′, and a second pull-down transistor T4′. The logic circuit 30b outputs the first driving signal to the Q node and outputs the second driving signal to the QB node. The first pull-up transistor T1′ can pull-up the scan signal output terminal of the second GIP driver 300b in response to the first drive signal. The second pull-down transistor T2′ pulls down the sensing signal output terminal of the second GIP driver 300b in response to the second driving signal. The second pull-up transistor T3′ pulls-up the sensing signal output terminal of the second GIP driver 300b in response to the first driving signal. The second pull-down transistor T4′ pulls down the scan signal output terminal of the second GIP driver 300b in response to the second driving signal.

The first transfer circuit 310a outputs the scan signal of the first GIP driver 300a selectively to the first scan line SCL1 and the second scan line SCL2 among the plurality of scan lines, and outputs the sensing signal of the first GIP driver 300a selectively to the first sensing line SENL1 and the second sensing line SENL2 among the plurality of sensing lines. In this embodiment, the first sensing line SENL1 can be an odd-numbered sensing line among the plurality of sensing lines SL, and the second sensing line SENL2 can be an even-numbered sensing line among the plurality of sensing lines SL. In this embodiment, the first scan line SCL1 may be an odd-numbered scan line among the plurality of scan lines, and the second scan line SCL2 may be an even-numbered scan line among the plurality of scan lines.

The second transfer circuit 310b outputs the scan signal of the second GIP driver 300b selectively to the first scan line SCL1 and the second scan line SCL2 among the plurality of scan lines, and outputs the sensing signal of the second GIP driver 300b selectively to the first sensing line SENL1 and the second sensing line SENL2 among the plurality of sensing lines.

For example, for a first frame, the first transfer circuit 310a is configured to transfer the scan signal output from the first GIP driver 300a to one of the first scan line SCL1 and the second scan line SCL2, and the second transfer circuit 310b is configured to transfer the scan signal output from the second GIP driver 300b to the other of the first scan line SCL1 and the second scan line SCL2, wherein for a second frame subsequent to the first frame, the first transfer circuit 310a is configured to transfer the scan signal output from the first GIP driver 300a to the other of the first scan line SCL1 and the second scan line SCL2, and the second transfer circuit 310b is configured to transfer the scan signal output from the second GIP driver 300b to one of the first scan line SCL1 and the second scan line SCL2. Further, for the first frame, the first transfer circuit 310a is configured to transfer the scan signal output from the first GIP driver 300a to one of the first sensing line SENL1 and the second sensing line SENL2, and the second transfer circuit 310b is configured to transfer the scan signal output from the second GIP driver 300b to the other of the first sensing line SENL1 and the second sensing line SENL2, wherein for the second frame subsequent to the first frame, the first transfer circuit 310a is configured to transfer the scan signal output from the first GIP driver 300a to the other of the first sensing line SENL1 and the second sensing line SENL2, and the second transfer circuit 310b is configured to transfer the scan signal output from the second GIP driver 300b to one of the first sensing line SENL1 and the second sensing line SENL2.

According to various embodiments, the scan signal output terminal of the first GIP driver 300a can be connected to the odd-numbered scan line among the plurality of scan lines for the n-th frame (n is a positive integer), and can be connected to the even-numbered scan line among the plurality of scan lines for the (n+1)-th frame. In addition, the scan signal output terminal of the second GIP driver 300b can be connected to the even-numbered scan line SL1 for the n-th frame and can be connected to the odd-numbered scan line for the (n+1)-th frame.

The sensing signal output terminal of the first GIP driver 300a can be connected to the odd-numbered sensing line among the plurality of sensing lines for the n-th frame (n is a positive integer), and can be connected to the even-numbered sensing line for the (n+1)-th frame. In addition, the sensing signal output terminal of the second GIP driver 300b can be connected to the even-numbered sensing line for the n-th frame, and can be connected to the odd-numbered sensing line for the (n+1)-th frame.

According to various embodiments, in the display device, for the same frame, one of the scan signal output terminals of the first GIP driver 300a and the second GIP driver 300b is selectively connected to one of the odd-numbered scan line and the even-numbered scan line among the plurality of scan lines, while the other of the scan signal output terminals of the first GIP driver 300a and the second GIP driver 300b is selectively connected to the other of the odd-numbered scan line and the even-numbered scan line among the plurality of scan lines. Conventionally, the image quality is degraded due to a difference between an output input to a position far away from the left or right GIP driver and an output input to a position closer to the left or right GIP driver in an edge area of the display panel. However, using the above configuration of the present disclosure, the difference can be removed such that the brightness of the display panel can be maintained at the average luminance in the edge area.

In addition, for the same frame, the display device connects one of the sensing signal output terminals of the first GIP driver 300a and the second GIP driver 300b to one of the odd-numbered sensing line and the even-numbered sensing line among the plurality of sensing lines, and connects the other of the sensing signal output terminals of the first GIP driver 300a and the second GIP driver 300b to the other of the odd-numbered sensing line and the even-numbered sensing line among the plurality of sensing lines. Conventionally, the image quality is degraded due to a difference between an output input to a position far away from the left or right GIP driver and an output input to a position closer to the left or right GIP driver in an edge area of the display panel. However, using the above configuration of the present disclosure, the difference can be removed such that the brightness of the display panel can be maintained at the average luminance in the edge area.

In addition, the display device connects the respective outputs of the first GIP driver 300a and the second GIP driver 300b selectively to two scan lines, respectively. Thus, there is no need to reduce the GIP driver dimension by ½, thereby improving output characteristics compared to the existing DRD scheme.

In addition, the display device connects the respective outputs of the first GIP driver 300a and the second GIP driver 300b selectively to the two scan lines, thereby facilitating the GIP driver design of the small and medium-sized display panel having the high PPI or DRD scheme.

In addition, the display device outputs one of the scan signals of the first GIP driver 300a and the second GIP driver 300b to one of the odd-numbered scan line and the even-numbered scan line and outputs the other of the scan signals of the first GIP driver 300a and the second GIP driver 300b to the other of the odd-numbered scan line and the even-numbered scan line for one of two consecutive frames, and outputs one of the scan signals of the first GIP driver 300a and the second GIP driver 300b to the other of the odd-numbered scan line and the even-numbered scan line and outputs the other of the scan signals of the first GIP driver 300a and the second GIP driver 300b to one of the odd-numbered scan line and the even-numbered scan line for the other of two consecutive frames. Thus, the brightness and darkness levels of the pixels are uniform, thereby preventing occurrence of a defect in a shape of a column line.

For example, for a first frame, the first transfer circuit 310a may be configured to transfer the scan signal from the first GIP driver 300a to one of the first scan line SCL1 and the second scan line SCL2, and transfer the sensing signal from the first GIP driver 300a to one of the first sensing line SENL1 and the second sensing line SENL2, while the second transfer circuit 310b may be configured to transfer the scan signal from the second GIP driver 300b to the other of the first scan line SCL1 and the second scan line SCL2, and transfer the sensing signal from the second GIP driver 300b to the other of the first sensing line SENL1 and the second sensing line SENL2.

In addition, the display device outputs one of the scan signals of the first GIP driver 300a and the second GIP driver 300b to one of the odd-numbered scan line and the even-numbered scan line and outputs the other of the scan signals of the first GIP driver 300a and the second GIP driver 300b to the other of the odd-numbered scan line and the even-numbered scan line for one of two consecutive frames, and outputs one of the scan signals of the first GIP driver 300a and the second GIP driver 300b to the other of the odd-numbered scan line and the even-numbered scan line and outputs the other of the scan signals of the first GIP driver 300a and the second GIP driver 300b to one of the odd-numbered scan line and the even-numbered scan line for the other of two consecutive frames, such that the display device can improve the image quality.

In addition, the display device connects the respective outputs of the first GIP driver 300a and the second GIP driver 300b selectively to two scan lines, respectively. Thus, it is not necessary to reduce the GIP driver dimension, and thus the display device DD can be appropriately applied to a high-PPI or DRD type display panel.

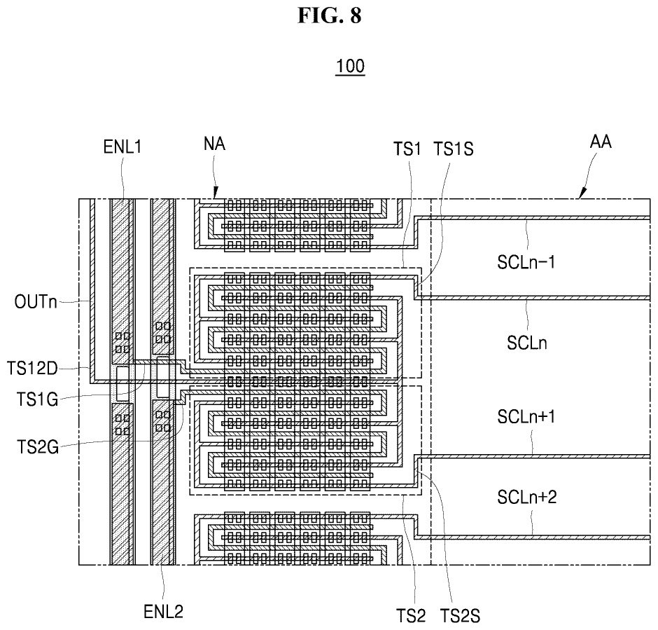

FIG. 8 is a plan view of a display panel included in an organic light-emitting display device according to an embodiment of the present disclosure.

In this regard, FIG. 8 is an enlarged view of a portion of the display panel 100 for convenience of illustration and for describing a relationship in which one output terminal OUTn of the GIP driver is connected to two scan lines SCLn and SCLn+1 via a first transfer transistor TS1 and a second transfer transistor TS2, respectively.

The display panel 100 can be divided into a display area AA and a non-display area NA. A plurality of pixels PX, a plurality of scan lines SCLn−1, SCLn, SCLn+1, and SCLn+2, a plurality of data lines DL, and a reference voltage line RL can be disposed in the display area AA. In the non-display area NA, the GIP driver, the output terminal OUTn of the GIP driver, enable lines ENL1 and ENL2, and the electrodes of the first transfer transistor TS1, and the second transfer transistor TS2 can be disposed.

Referring to FIG. 8, the output terminal OUTn of the GIP driver is connected to a drain electrode TS12D of each of the first transfer transistor TS1 and the second transfer transistor TS2. A gate electrode TS1G of the first transfer transistor TS1 is connected to the first enable line ENL1 to which the first enable signal EN1 is supplied. A source electrode TS1S of the first transfer transistor TS1 is connected to the n-th scan line SCLn.

In addition, a gate electrode TS2G of the second transfer transistor TS2 is connected to the second enable line ENL2 to which the second enable signal EN2 is supplied. A source electrode TS2S of the second transfer transistor TS2 is connected to the (n+1)-th scan line SCLn+1.

That is, one output terminal OUTn of the GIP driver is connected to the first scan line SCLn or the second scan line SCLn+1 via each of the first transfer transistor TS1 and the second transfer transistor TS2. When the first enable signal EN1 is activated, the output terminal OUTn is connected to the first scan line SCLn via the first transfer transistor TS1. On the contrary, when the second enable signal EN2 is activated, the output terminal OUTn is connected to the second scan line SCLn via the second transfer transistor TS2.

For example, when the GIP driver outputting four scan signals as the same number of outputs as in the SRD scheme is designed, eight scan lines can be driven via the transfer circuit including the first transfer transistor TS1 and the second transfer transistor TS2. In addition, for example, the four scan lines can be alternately driven on one frame basis.

As described above, each output terminal of the GIP driver can be selectively connected to the two scan lines via the transfer circuit, thereby enabling the GIP driver design without reducing the GIP driver dimension. Such GIP driver design can be appropriately applied to a high PPI or DRD type display panel.

The display device and the gate driving circuit according to aspects and embodiments of the present disclosure as described above can be described as follows.

A first aspect of the present disclosure provides a display device comprising: a display panel including a plurality of scan lines; a first GIP (gate-in-panel) driver and a second GIP driver respectively disposed on both opposing sides of the display panel, wherein each of the first GIP driver and the second GIP driver is configured to sequentially output a scan signal; a first transfer circuit disposed between and connected to the display panel and the first GIP driver and configured to transfer the scan signal of the first GIP driver selectively to a first scan line and a second scan line among the plurality of scan lines; and a second transfer circuit disposed between and connected to the display panel and a second GIP driver and configured to transfer the scan signal of the second GIP driver selectively to the first scan line and the second scan line.

In accordance with some embodiments of the first aspect of the present disclosure, for a first frame, the first transfer circuit is configured to transfer the scan signal output from the first GIP driver to one of the first scan line and the second scan line, and the second transfer circuit is configured to transfer the scan signal output from the second GIP driver to the other of the first scan line and the second scan line, wherein for a second frame subsequent to the first frame, the first transfer circuit is configured to transfer the scan signal output from the first GIP driver to the other of the first scan line and the second scan line, and the second transfer circuit is configured to transfer the scan signal output from the second GIP driver to the one of the first scan line and the second scan line.

In accordance with some embodiments of the first aspect of the present disclosure, the first transfer circuit includes: a first transfer transistor configured to transfer the scan signal of the first GIP driver to the first scan line in response to a first enable signal; and a second transfer transistor configured to transfer the scan signal of the first GIP driver to the second scan line in response to a second enable signal.

In accordance with some embodiments of the first aspect of the present disclosure, the second transfer circuit includes: a third transfer transistor configured to transfer the scan signal of the second GIP driver to the first scan line in response to the second enable signal; and a fourth transfer transistor configured to transfer the scan signal of the second GIP driver to the second scan line in response to the first enable signal.

In accordance with some embodiments of the first aspect of the present disclosure, each of the first transfer transistor and the fourth transfer transistor is configured to be turned on for an odd-numbered frame, wherein each of the second transfer transistor and the third transfer transistor is configured to be turned on for an even-numbered frame.

In accordance with some embodiments of the first aspect of the present disclosure, a logic level of the first enable signal and a logic level of the second enable signal are inverted relative to each other, wherein the logic levels thereof are inverted relative to each other on a single frame basis.

In accordance with some embodiments of the first aspect of the present disclosure, the first GIP driver includes a first logic circuit configured to apply the first enable signal and the second enable signal, wherein the second GIP driver includes a second logic circuit configured to apply the first enable signal and the second enable signal.

In accordance with some embodiments of the first aspect of the present disclosure, the first GIP driver further includes a pull-up transistor configured to pull-up an output terminal of the first GIP driver in response to a first driving signal of the first logic circuit; and a pull-down transistor configured to pull down the output terminal of the first GIP driver in response to a second driving signal of the first logic circuit.

In accordance with some embodiments of the first aspect of the present disclosure, the second GIP driver further includes a pull-up transistor configured to pull-up an output terminal of the second GIP driver in response to a first driving signal of the second logic circuit; and a pull-down transistor configured to pull down the output terminal of the second GIP driver in response to a second driving signal of the second logic circuit.

In accordance with some embodiments of the first aspect of the present disclosure, each of the first enable signal and the second enable signal is applied as an external clock signal and from an external source to the display panel.

In accordance with some embodiments of the first aspect of the present disclosure, the first transfer circuit is configured to transfer the scan signal of the first GIP driver to the first scan line for an n-th frame, and to transfer the scan signal of the first GIP driver to the second scan line for a (n+1)-th frame, wherein n is a positive integer.

In accordance with some embodiments of the first aspect of the present disclosure, the second transfer circuit is configured to transfer the scan signal of the second GIP driver to the second scan line for the n-th frame, and transfer the scan signal of the second GIP driver to the first scan line for the (n+1)-th frame.

In accordance with some embodiments of the first aspect of the present disclosure, the first scan line is an odd-numbered scan line among the plurality of scan lines, and the second scan line is an even-numbered scan line among the plurality of scan lines.

In accordance with some embodiments of the first aspect of the present disclosure, the display panel includes a plurality of sub-pixels, wherein each of the plurality of scan lines is connected to a gate electrode of a scan transistor for supplying a data voltage to the sub-pixel, and is connected to a gate electrode of a sensing transistor for supplying a reference voltage to the sub-pixel.

In accordance with some embodiments of the first aspect of the present disclosure, the first GIP driver and the second GIP driver are respectively disposed on both opposing sides of the display panel, the first transfer circuit is disposed between and connected to the display panel and the first GIP driver, and the second transfer circuit disposed between and connected to the display panel and a second GIP driver.

A second aspect of the present disclosure provides a gate driving circuit comprising: a first GIP driver disposed on a left side of a display panel; and a second GIP driver disposed on a right side of the display panel, wherein a scan signal of the first GIP driver is transferred to an odd-numbered scan line among a plurality of scan lines for an n-th frame, and is transferred to an even-numbered scan line for an (n+1)-th frame, where n is a positive integer, wherein a scan signal of the second GIP driver is transferred to the even-numbered scan line for the n-th frame, and is transferred to the odd-numbered scan line for the (n+1)-th frame.

In accordance with some embodiments of the second aspect of the present disclosure, the gate driving circuit further comprises: a first transfer circuit disposed between and connected to the first GIP driver and the display panel and configured to transfer the scan signal of the first GIP driver selectively to one of the odd-numbered scan line and the even-numbered scan line; and a second transfer circuit disposed between and connected to the second GIP driver and the display panel and configured to transfer the scan signal of the second GIP driver selectively to one of the odd-numbered scan line and the even-numbered scan line.

In accordance with some embodiments of the second aspect of the present disclosure, the first transfer circuit includes: a first transfer transistor configured to transfer the scan signal of the first GIP driver to the odd-numbered scan line in response to a first enable signal; and a second transfer transistor configured to transfer the scan signal of the first GIP driver to the even-numbered line in response to a second enable signal.

In accordance with some embodiments of the second aspect of the present disclosure, the second transfer circuit includes: a third transfer transistor configured to transfer the scan signal of the second GIP driver to the even-numbered line in response to the second enable signal; and a fourth transfer transistor configured to transfer the scan signal of the second GIP driver to the odd-numbered line in response to the first enable signal.

In accordance with some embodiments of the second aspect of the present disclosure, each of the first GIP driver and the second GIP driver includes a plurality of stages sequentially supplying the scan signal to the plurality of scan lines, wherein each of the plurality of stages includes: a logic circuit configured to output a first driving signal to a Q node and output a second driving signal to a QB node; a pull-up transistor configured to pull-up an output terminal of the first GIP driver or the second GIP driver in response to the first driving signal; and a pull-down transistor configured to pull down the output terminal of the first GIP driver or the second GIP driver in response to the second driving signal.

In accordance with some embodiments of the second aspect of the present disclosure, the logic circuit of the first GIP driver is configured to supply the first enable signal and the second enable signal to the first transfer circuit, wherein the logic circuit of the second GIP driver is configured to supply the first enable signal and the second enable signal to the second transfer circuit.

In accordance with some embodiments of the second aspect of the present disclosure, each of the first enable signal and the second enable signal is applied as an external clock signal and from an external source to the display panel.

A third aspect of the present disclosure provides a display device comprising: a display panel including a plurality of scan lines and a plurality of sensing lines; a first GIP driver and a second GIP driver respectively disposed on both opposing sides of the display panel, wherein each of the first GIP driver and the second GIP driver is configured to sequentially output a scan signal and sequentially output a sensing signal to the display panel; a first transfer circuit configured to alternately transfer the scan signal of the first GIP driver to a first scan line and a second scan line among the plurality of scan lines, and to alternately transfer the sensing signal of the first GIP driver to a first sensing line and a second sensing line among the plurality of sensing lines; and a second transfer circuit configured to alternately transfer the scan signal of the second GIP driver to the first scan line and the second scan line, and to alternately transfer the sensing signal of the second GIP driver to the first sensing line and the second sensing line.

In accordance with some embodiments of the third aspect of the present disclosure, for a first frame, the first transfer circuit is configured to transfer the scan signal from the first GIP driver to one of the first scan line and the second scan line, and transfer the sensing signal from the first GIP driver to one of the first sensing line and the second sensing line, while the second transfer circuit is configured to transfer the scan signal from the second GIP driver to the other of the first scan line and the second scan line, and transfer the sensing signal from the second GIP driver to the other of the first sensing line and the second sensing line, wherein for a second frame subsequent to the first frame, the first transfer circuit is configured to transfer the scan signal from the first GIP driver to the other of the first scan line and the second scan line, and transfer the sensing signal from the first GIP driver to the other of the first sensing line and the second sensing line, while the second transfer circuit is configured to transfer the scan signal output from the second GIP driver to the one of the first scan line and the second scan line and transfer the sensing signal from the second GIP driver to the one of the first sensing line and the second sensing line.

A fourth aspect of the present disclosure provides a gate driving circuit comprising: a first GIP driver and a second GIP driver, wherein each of the first GIP driver and the second GIP driver is configured to sequentially output a scan signal and sequentially output a sensing signal; a first transfer circuit configured to alternately transfer the scan signal of the first GIP driver to a first scan line and a second scan line among a plurality of scan lines, and to alternately transfer the sensing signal of the first GIP driver to a first sensing line and a second sensing line among a plurality of sensing lines; and a second transfer circuit configured to alternately transfer the scan signal of the second GIP driver to the first scan line and the second scan line, and to alternately transfer the sensing signal of the second GIP driver to the first sensing line and the second sensing line.

Although some embodiments of the present disclosure have been described above with reference to the accompanying drawings, the present disclosure may not be limited to some embodiments and can be implemented in various different forms. Those of ordinary skill in the technical field to which the present disclosure belongs will be able to appreciate that the present disclosure can be implemented in other specific forms without changing the technical idea or essential features of the present disclosure. Therefore, it should be understood that some embodiments as described above are not restrictive but illustrative in all respects.

What is claimed is:

1. A display device comprising:
a display panel including a plurality of scan lines;
a first gate-in-panel (GIP) driver and a second GIP driver, wherein each of the first GIP driver and the second GIP driver is configured to sequentially output a scan signal;
a first transfer circuit configured to transfer the scan signal of the first GIP driver selectively to a first scan line and a second scan line among the plurality of scan lines; and
a second transfer circuit configured to transfer the scan signal of the second GIP driver selectively to the first scan line and the second scan line.

2. The display device of claim 1, wherein for a first frame, the first transfer circuit is configured to transfer the scan signal output from the first GIP driver to one of the first scan line and the second scan line, and the second transfer circuit is configured to transfer the scan signal output from the second GIP driver to the other of the first scan line and the second scan line, and
wherein for a second frame subsequent to the first frame, the first transfer circuit is configured to transfer the scan signal output from the first GIP driver to the other of the first scan line and the second scan line, and the second transfer circuit is configured to transfer the scan signal output from the second GIP driver to the one of the first scan line and the second scan line.

3. The display device of claim 2, wherein the first transfer circuit includes:
a first transfer transistor configured to transfer the scan signal of the first GIP driver to the first scan line in response to a first enable signal; and
a second transfer transistor configured to transfer the scan signal of the first GIP driver to the second scan line in response to a second enable signal.

4. The display device of claim 3, wherein the second transfer circuit includes:
a third transfer transistor configured to transfer the scan signal of the second GIP driver to the first scan line in response to the second enable signal; and
a fourth transfer transistor configured to transfer the scan signal of the second GIP driver to the second scan line in response to the first enable signal.

5. The display device of claim 4, wherein each of the first transfer transistor and the fourth transfer transistor is configured to be turned on for an odd-numbered frame, and
wherein each of the second transfer transistor and the third transfer transistor is configured to be turned on for an even-numbered frame.

6. The display device of claim 5, wherein a logic level of the first enable signal and a logic level of the second enable signal are inverted relative to each other, and
wherein the logic levels thereof are inverted relative to each other on a single frame basis.

7. The display device of claim 6, wherein the first GIP driver includes a first logic circuit configured to apply the first enable signal and the second enable signal, and
wherein the second GIP driver includes a second logic circuit configured to apply the first enable signal and the second enable signal.

8. The display device of claim 7, wherein the first GIP driver further includes a pull-up transistor configured to pull-up an output terminal of the first GIP driver in response to a first driving signal of the first logic circuit; and a pull-down transistor configured to pull down the output terminal of the first GIP driver in response to a second driving signal of the first logic circuit.

9. The display device of claim 7, wherein the second GIP driver further includes a pull-up transistor configured to pull-up an output terminal of the second GIP driver in response to a first driving signal of the second logic circuit; and a pull-down transistor configured to pull down the output terminal of the second GIP driver in response to a second driving signal of the second logic circuit.

10. The display device of claim 6, wherein each of the first enable signal and the second enable signal is applied as an external clock signal and from an external source to the display panel.

11. The display device of claim 1, wherein the first transfer circuit is configured to transfer the scan signal of the first GIP driver to the first scan line for an n-th frame, and to transfer the scan signal of the first GIP driver to the second scan line for a (n+1)-th frame, wherein n is a positive integer.

12. The display device of claim 11, wherein the second transfer circuit is configured to transfer the scan signal of the second GIP driver to the second scan line for the n-th frame, and transfer the scan signal of the second GIP driver to the first scan line for the (n+1)-th frame.

13. The display device of claim 1, wherein the first scan line is an odd-numbered scan line among the plurality of scan lines, and the second scan line is an even-numbered scan line among the plurality of scan lines.

14. The display device of claim 1, wherein the display panel includes a plurality of sub-pixels, and
wherein each of the plurality of scan lines is connected to a gate electrode of a scan transistor for supplying a data voltage to the corresponding sub-pixel, and is connected to a gate electrode of a sensing transistor for supplying a reference voltage to the corresponding sub-pixel.

15. The display device of claim 1, wherein
the first GIP driver and the second GIP driver are respectively disposed on both opposing sides of the display panel,
the first transfer circuit is disposed between and connected to the display panel and the first GIP driver, and
the second transfer circuit disposed between and connected to the display panel and a second GIP driver.

16. A gate driving circuit comprising:
a first gate-in-panel (GIP) driver disposed on a first side of a display panel; and
a second GIP driver disposed on a second side of the display panel,
wherein a scan signal of the first GIP driver is transferred to an odd-numbered scan line among a plurality of scan lines for an n-th frame, and is transferred to an even-numbered scan line for an (n+1)-th frame, where n is a positive integer, and
wherein a scan signal of the second GIP driver is transferred to the even-numbered scan line for the n-th frame, and is transferred to the odd-numbered scan line for the (n+1)-th frame.

17. The gate driving circuit of claim 16, wherein the gate driving circuit further comprises:
a first transfer circuit disposed between and connected to the first GIP driver and the display panel, and configured to transfer the scan signal of the first GIP driver selectively to one of the odd-numbered scan line and the even-numbered scan line; and
a second transfer circuit disposed between and connected to the second GIP driver and the display panel, and configured to transfer the scan signal of the second GIP driver selectively to one of the odd-numbered scan line and the even-numbered scan line.

18. The gate driving circuit of claim 17, wherein the first transfer circuit includes:
a first transfer transistor configured to transfer the scan signal of the first GIP driver to the odd-numbered scan line in response to a first enable signal; and
a second transfer transistor configured to transfer the scan signal of the first GIP driver to the even-numbered scan line in response to a second enable signal.

19. The gate driving circuit of claim 18, wherein the second transfer circuit includes:
a third transfer transistor configured to transfer the scan signal of the second GIP driver to the odd-numbered scan line in response to the second enable signal; and
a fourth transfer transistor configured to transfer the scan signal of the second GIP driver to the even-numbered scan line in response to the first enable signal.

20. The gate driving circuit of claim 19, wherein each of the first GIP driver and the second GIP driver includes a plurality of stages configured to sequentially supply the scan signal to the plurality of scan lines, and
wherein each of the plurality of stages includes:
a logic circuit configured to output a first driving signal to a Q node and output a second driving signal to a QB node;
a pull-up transistor configured to pull-up an output terminal of the first GIP driver or the second GIP driver in response to the first driving signal; and
a pull-down transistor configured to pull down the output terminal of the first GIP driver or the second GIP driver in response to the second driving signal.

21. The gate driving circuit of claim 20, wherein the logic circuit of the first GIP driver is configured to supply the first enable signal and the second enable signal to the first transfer circuit, and
wherein the logic circuit of the second GIP driver is configured to supply the first enable signal and the second enable signal to the second transfer circuit.

22. The gate driving circuit of claim 18, wherein each of the first enable signal and the second enable signal is applied as an external clock signal and from an external source to the display panel.

23. A display device comprising:
a display panel including a plurality of scan lines and a plurality of sensing lines;
a first gate-in-panel (GIP) driver and a second GIP driver respectively disposed on sides of the display panel, wherein each of the first GIP driver and the second GIP driver is configured to sequentially output a scan signal and sequentially output a sensing signal to the display panel;
a first transfer circuit configured to alternately transfer the scan signal of the first GIP driver to a first scan line and a second scan line among the plurality of scan lines, and to alternately transfer the sensing signal of the first GIP driver to a first sensing line and a second sensing line among the plurality of sensing lines; and
a second transfer circuit configured to alternately transfer the scan signal of the second GIP driver to the first scan line and the second scan line, and to alternately transfer the sensing signal of the second GIP driver to the first sensing line and the second sensing line.

24. The display device of claim 23, wherein the first GIP driver and the second GIP driver are respectively disposed on both opposing sides of the display panel, and
wherein for a first frame, the first transfer circuit is configured to transfer the scan signal from the first GIP driver to one of the first scan line and the second scan line, and transfer the sensing signal from the first GIP driver to one of the first sensing line and the second sensing line, while the second transfer circuit is configured to transfer the scan signal from the second GIP driver to the other of the first scan line and the second scan line, and transfer the sensing signal from the second GIP driver to the other of the first sensing line and the second sensing line, and
wherein for a second frame subsequent to the first frame, the first transfer circuit is configured to transfer the scan signal from the first GIP driver to the other of the first scan line and the second scan line, and transfer the sensing signal from the first GIP driver to the other of the first sensing line and the second sensing line, while the second transfer circuit is configured to transfer the scan signal output from the second GIP driver to the one of the first scan line and the second scan line and transfer the sensing signal from the second GIP driver to the one of the first sensing line and the second sensing line.

25. A gate driving circuit comprising:
a first GIP driver and a second GIP driver, wherein each of the first GIP driver and the second GIP driver is configured to sequentially output a scan signal and sequentially output a sensing signal;
a first transfer circuit configured to alternately transfer the scan signal of the first GIP driver to a first scan line and a second scan line among a plurality of scan lines, and to alternately transfer the sensing signal of the first GIP driver to a first sensing line and a second sensing line among a plurality of sensing lines; and
a second transfer circuit configured to alternately transfer the scan signal of the second GIP driver to the first scan line and the second scan line, and to alternately transfer the sensing signal of the second GIP driver to the first sensing line and the second sensing line.
